(19) United States
(12) Patent Application Publication
(10) Pub. No.: US 2009/0089852 A1
(43) Pub. Date: Apr. 2, 2009

(54) Automated Multimedia Channel Error Reporting from Viewer Premises

(75) Inventors: Donald Randolph, Ypsilanti, MI (US); Bradley C. Griner, Kansas City, MO (US); Jeffrey W. Zimmerman, Lenexa, KS (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/865,407

(22) Filed: Oct. 1, 2007

(51) Int. Cl. H04N 7/173

(52) U.S. Cl. 725/131

(57) ABSTRACT

Multimedia data representative of a multimedia channel is received at a set top box (STB) device located at a viewer's premises from a service provider. The multimedia data is processed at the STB device for presentation of the multimedia channel at a display device located at the viewer's premises. The STB device identifies an artifact during the processing of the multimedia data that is expected to affect the presentation of the multimedia channel and generates an error indicator based on the artifact. The STB device provides the error indicator for reception by the service provider. The error indicator then may be used by the service provider to identify and correct any related errors or malfunctions.

### FIELD OF THE DISCLOSURE

The present disclosure generally relates to the provision of multimedia content, and more particularly, to reporting errors in the presentation of the multimedia content at a viewer's premises.

### BACKGROUND

Service providers, such as cable television providers and satellite television providers, typically make a large number of multimedia channels available to viewers. In an effort to ensure a quality viewing experience, service providers monitor the provision of the multimedia channels to the viewers to identify any problems that may arise in the provision of the multimedia channels. Conventionally, service providers employ personnel who repeatedly scan through each multimedia channel to confirm proper provision of the channel. However, due to the large number of multimedia channels provided, a significant time period can lapse between scans of the same channel. To illustrate, assuming there are 300 multimedia channels to scan with a ten second scan period per channel, each multimedia channel will be scanned only once ever 50 minutes. In this example, there would be the potential for a problem to be present for up to 50 minutes before it is noted by the operator, or potentially longer in the event that problem is intermittent and therefore may not be present during a particular scan of the channel. The presence of a problem for even a fraction of such as duration likely would aggravate viewers, resulting in numerous complaints or canceled service subscriptions.

This problem often is exacerbated by the centralized location of the operator. Service providers typically utilize a distributed network for delivering multimedia content to viewers in different markets, whereby local multimedia content can be introduced for local markets. Thus, a problem that appears in a multimedia channel for one region may not be present for the multimedia channel for a different region, and thus the operator may not ever become aware of a problem depending on the nature of the video feed to the operator.

To overcome the distribution issue and to eliminate the potential for operator error, some service providers employ automated channel scanners that are situated at various locations within the service provider's network. As with the operators, these automated channel scanners scan through each multimedia channel in sequence to identify potential problems. However, considerable time must be spent on each multimedia channel due to the time needed to acquire and synchronize with a multimedia channel and the time needed to ascertain whether there is a problem affecting the quality of the display of the multimedia channel. Thus, there also is a considerable lapse between scans of a multimedia channel by these automated channel scanners. Further, the implementation of this conventional automated channel scan system can be cost prohibitive due to the number of automated channel scanners needed to comprehensively cover the distribution network of the service provider. Accordingly, an improved technique for identifying and reporting errors in multimedia channels would be advantageous.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an example multimedia content distribution system in accordance with at least one embodiment of the present disclosure;

FIG. 2 is a flow diagram illustrating an example method for monitoring and reporting errors in multimedia channels via set top box (STB) devices in accordance with at least one embodiment of the present disclosure;

FIG. 3 is a diagram illustrating an example operation of the multimedia content distribution system of FIG. 1 for reporting errors in multimedia channels being presented accordance with at least one embodiment of the present disclosure;

FIG. 4 is a block diagram illustrating an example STB device configured to report errors in presented multimedia channel in accordance with at least one embodiment of the present disclosure;

FIG. 5 is a block diagram illustrating an example Internet Protocol Television (IPTV) network implementing a STB device-based error reporting technique in accordance with at least one embodiment of the present disclosure; and

FIG. 6 is a diagram illustrating an example computer system for implementing one or more of the techniques described herein in accordance with at least one embodiment of the present disclosure.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

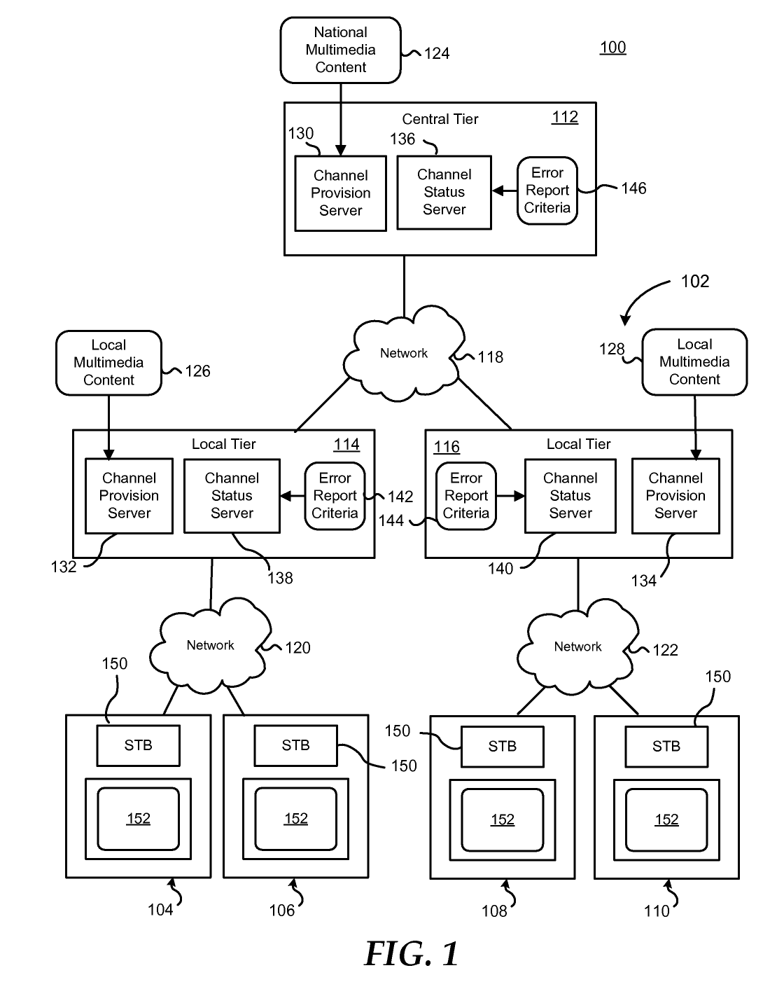

FIGS. 1-6 illustrate example techniques for monitoring multimedia channels at a set top box (STB) device to identify any artifacts that occur during processing of the multimedia channel that are expected to affect the presentation of the multimedia channel and notify a service provider accordingly. In at least one embodiment, the STB device monitors the processing and presentation of the multimedia data representative of the multimedia channel. In the event that an artifact in the processing or presentation occurs, the STB device can generate an error indicator based on the artifact and then transmit the error indicator to the service provider for error reporting purposes. In one embodiment, the STB device can filter identified artifacts to ensure that an error indicator is provided to the service provider only under certain conditions. The service provider can utilize error indicators received from STB devices within its multimedia content distribution network to generate an alarm report for the multimedia channel. For ease of reference, a report generated by a channel status server at a local tier is referred to as an error report and a report generated by a channel status server at the central tier is referred to as an alarm report, although they both may have the same format and content. As with the generation of error indicators by the STB devices, the service provider can filter error indicators to ensure that an alarm report for the multimedia channel is generated only under certain conditions. By implementing STB devices to monitor multimedia channels as they are being viewed and report any identified problems, the delay between the occurrence of a problem and the service provider becoming aware of the problem can be shortened compared to conventional channel scanning techniques, thereby reducing the potential for viewer frustration and dissatisfaction.

The term “multimedia channel” refers to a stream of video content, a stream of audio content, or a combination thereof. The term “presentation” refers to the display of video content in a video context, the audible output of audio content in an audio context, or a combination thereof. Accordingly, the presentation of a multimedia channel includes one or both of a display of at least a portion of the stream of video content of the multimedia channel and the audible output of at least a portion of the stream of audio content of the multimedia channel.

For ease of illustration, certain techniques disclosed herein are described in the context of an implementation based on a Simple Network Management Protocol (SNMP). Other reporting protocols, conventional or proprietary, can be implemented using the guidelines provided herein without departing from the scope of the present disclosure. The example techniques disclosed herein also are described in the context of an Internet Protocol Television (IPTV) network utilizing a STB device to interface between a display device, such as a television or computer, and the multimedia distribution network of a service provider. However, these techniques also can be implemented in other contexts without departing from the scope of the present disclosure.

FIG. 1 illustrates a multimedia content distribution system 100 for providing multimedia channels to viewer premises for presentation in accordance with at least one embodiment of the present disclosure. In the depicted example, the multimedia content distribution system 100 includes a content distribution network 102 of a service provider, such as a cable television provider or satellite television provider, and a plurality of viewer premises, such as viewer premises 104, 106, 108, and 110 (collectively, “viewer premises 104-110”). The content distribution network 102 represents the components of the multimedia content distribution system 100 that are located remote from the viewer premises 104-110 and are maintained by the service provider or a third party. In one embodiment, the content distribution network 102 includes a hierarchy of tiers, such as a central tier 112 and a plurality of local tiers, such as local tiers 114 and 116. Although FIG. 1 illustrates an example implementation with two local tiers, with each local tier supporting two viewer premises, it will be appreciated that actual implementations typically will have a larger number of local tiers and support a larger number of viewer premises.

The central tier 112 can be connected to the local tiers 114 and 116 via one or more networks 118. The network 118 can include, for example, a private or proprietary communications network maintained by the service provider. Alternately, the network 118 can include a public communications network, such as the Internet, a wireless network (e.g., a radio frequency (RF) television broadcast network), a plain old telephone system (POTS) network, or a combination thereof. The local tiers 114 and 116, in turn, are connected to their respective viewer premises via networks 120 and 122, respectively. As with the network 118, the networks 120 and 122 can include a private or proprietary communications network or a public communications network, such as the Internet or a wireless network. In one embodiment, two or more of the networks 118, 120, and 122 are implemented as the same network.

Typically, the central tier 112 comprises a centralized server system which receives national multimedia content 124 from one or more content producers (e.g., network television producers, cable television producers, etc.) and distributes the national multimedia content 124 to the local tiers, which in turn receive supplemental local multimedia contents 126 and 128 (e.g., local network television content). The local tiers then distribute the national multimedia content 124 and the corresponding local multimedia content in the form of multimedia channels to viewer premises in their respective localities or markets.

In the illustrated example, the central tier 112 includes a channel provision server 130, the local tier 114 includes a channel provision server 132, and the local tier 116 includes a channel provision server 134 (collectively, “channel provision servers 130-134”). The channel provision server 130 of the central tier 112 is configured to provide some or all of the national multimedia content 124 to the local tiers 114 and 116 based on the channels selected by the respective viewer premises of the local tiers. The channel provision server 132 of the local tier 114, in turn, is configured to supplement the received national multimedia content with the local multimedia content 126 and provide at least a portion of the resulting multimedia content as one or more multimedia channels to the viewer premises 104 and 106. Similarly, the channel provision server 134 of the local tier 116 is configured to supplement the received national multimedia content with the local multimedia content 128 and provide at least a portion of the resulting multimedia content as one or more multimedia channels to the viewer premises 108 and 110.

Further, the central tier 112 includes a channel status server 136, the local tier 114 includes a channel status server 138, and the local tier 116 includes a channel status server 140 (collectively, “channel status servers 136-140”). The channel status server 138 of the local tier 114 is configured to receive error indicators regarding the presentation of multimedia channels from the viewer premises 104 and 106. From these received error indicators, the channel status server 138 can generate an error report and provide the error report to the channel status server 136 of the central tier 112.

In one embodiment, the channel status server 138 filters the received error indicators based on the application of one or more error reporting filter criteria 142 so as to reduce or eliminate the generation of error reports for transient artifacts, for false alarms, or for artifacts that are not expected to affect the quality of the presentation of the corresponding multimedia channel. Likewise, the channel status server 140 of the local tier 116 receives error indicators regarding the presentation of multimedia channels from the viewer premises 108 and 110, and from these received indicators, generates an error report for provision to the channel status server 136. The channel status server 140 can apply one or more error reporting filter criteria 144 to the error indicators so as to filter out error indicators resulting from transient artifacts, false alarms, or artifacts that are not expected to affect the presentation of the corresponding multimedia channel. In a similar manner, the channel status server 136 receives error reports from the channel status servers 138 and 140, and from these error reports, can selectively generate an alarm report to notify system monitoring and maintenance personnel that one or more multimedia channels are experiencing problems that likely need to be corrected. As with the channel status servers 138 and 140, the channel status server 136 can apply one or more error reporting filter criteria 146 to the received error reports to reduce or eliminate the likelihood of generating an alarm report for a transient problem or a problem that is not expected to affect the presentation of the corresponding multimedia channel.

Although the channel status servers 136-140 all can employ the same error reporting filter criteria to filter error indicators or error reports, it will be appreciated that due to their particular circumstances and configurations, the error reporting filter criteria may differ among the different tiers. To illustrate, the network 122 used to connect the local tier 116 to the viewer premises 108 and 110 may experience many more dropped packets (one example of an artifact) during normal operation than the network 120 used to connect the local tier 114 to the viewer premises 104 and 106. In recognition of this disparity during normal operations, the error reporting filter criteria 144 used by the channel status server 140 of the local tier 116 may have a higher dropped packet filter criterion than the dropped packet criterion of the error reporting filter criteria 142 used by the channel status server 138 of the local tier 114.

In the example of FIG. 1, each of the viewer premises 104-110 includes a STB device 150 and a display device 152. The STB device 150 is configured to provide an indicator of a multimedia channel selected by a viewer to the channel provision server of the corresponding local tier. The channel provision server of the local tier, in turn, provides multimedia data representative of the selected multimedia channel to the STB device 150, whereupon it is processed to generate a video stream and an audio stream for presentation at the display device 152. The multimedia data can include encoded multimedia data, such as Motion Pictures Experts Group (MPEG) encoded data or H.264 encoded data.

Further, the STB device 150 is configured to monitor the processing and presentation of the multimedia data to identify any artifacts that arise that may affect the presentation of the corresponding multimedia channel. The artifacts can include visual artifacts, such as macroblocking or tiling of the video, tearing of the frames of the video, a black screen or blank screen where there should be active video content, the dropping of one or more video packets that represent some portion of one or more video frames, a chroma or luminance level that is outside an expected range, and the like. The artifacts alternately can include audio artifacts, such as an audio level that is lower than or higher than an expected range, no audio output at all, and the like.

In the event that the STB device 150 identifies an artifact, the STB device 150 is configured to generate an error indicator based on the artifact and then provide the error indicator to the corresponding channel status server for processing as discussed above. In one embodiment, the STB device 150 is selective in its generation of an error indicator by filtering error indicators based on one or more error reporting filter criteria so as to reduce the occurrence of error indicators for false alarms, transient artifacts, or artifacts that are not likely to affect the presentation of the multimedia channel. To illustrate, the error reporting filter criteria can include one or more of: an artifact duration criterion (e.g., the artifact must be present for at least a predetermined duration before triggering the generation of an error indicator); an artifact frequency criterion (e.g., the artifact must occur with a minimum frequency before triggering the generation of an error indicator); an artifact type criterion (e.g., the artifact must be of a type identified as expected to affect a presentation of the multimedia channel), and the like.

In at least one embodiment, the error indicators issued by the STB devices 150 and the error reports issued by the channel status servers 138 and 140 comprise SNMP trap messages that are generated and transmitted in accordance with the SNMP protocol. However, alternate commercial or proprietary protocols may be used to generate and transmit error indicators in accordance with at least one embodiment of the present disclosure.

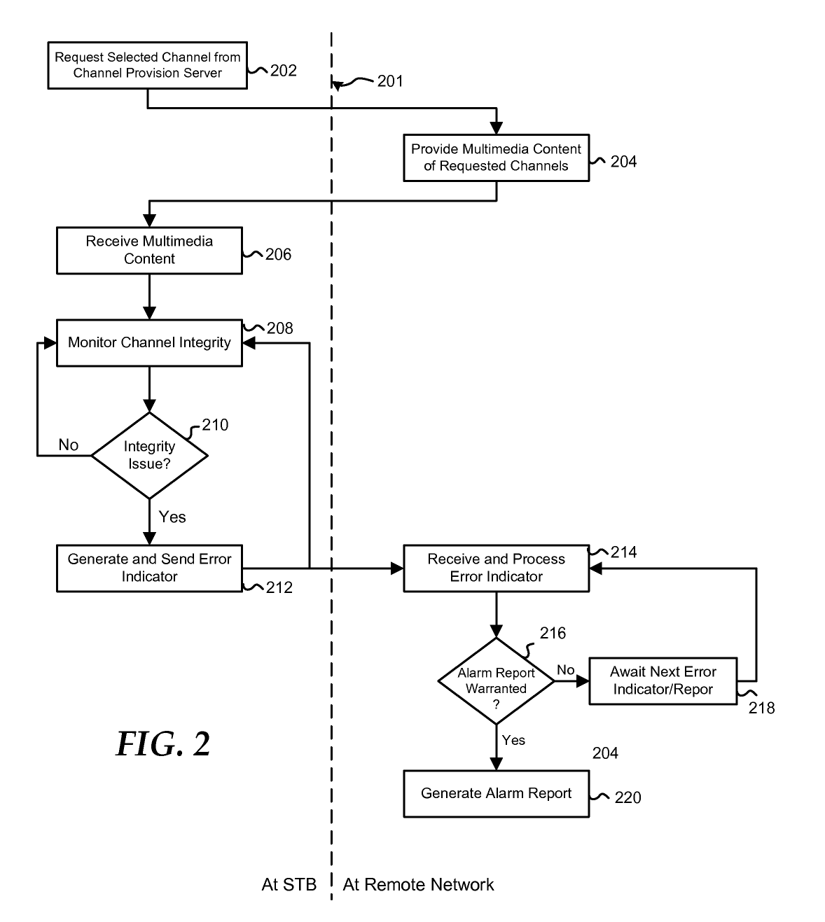

FIG. 2 illustrates an example method 200 of operation of the multimedia content distribution system 100 of FIG. 1 for the identification and reporting of errors in multimedia channels via an STB device at the viewer's premises in accordance with at least one embodiment of the present disclosure. As depicted, the processes represented by blocks to the left of hatched line 201 represent processes performed at the STB device 150 of the viewer's premises, and the processes represented by blocks to the right of the hatched line 201 represent processes performed at the content distribution network 102 external to the viewer's premises.

At block 202, a viewer provides to the STB device 150 a channel selection (e.g., input from a remote control device or via a button panel) that indicates a multimedia channel (or multiple multimedia channels) to be displayed at the display device 152 or other display device. The STB device 150 forwards a channel request to the channel provision server of the corresponding local tier. In response, the channel provision server accesses multimedia data representative of a requested multimedia channel and forwards the multimedia data to the STB device via one or more networks (e.g., an IP-based communications network) at block 204. At block 206, the STB device 150 receives the multimedia data and begins processing of the multimedia data for presentation. The multimedia data can include, for example, encoded multimedia data, such as MPEG2 or MPEG4 encoded data, H.264 data, and the like. Accordingly, processing of the multimedia data can include parsing the multimedia data into the corresponding encoded video and audio streams, decoding the video and audio streams, formatting the resulting decoded streams, and the like. The STB device 150 provides the video content and audio content of the multimedia channel to the display device 152 for presentation as it becomes ready during processing.

At block 208, the STB device 150 monitors the integrity of the multimedia channel as it is being processed and presented. Certain visual artifacts, such as macroblocking, tiling, frame tearing, black screens or blank screens, chroma values that are above or below a certain range, and dropped video packets, can affect the quality of the display of the video content of the multimedia channel. Likewise, certain audible artifacts, such as an audio level that is below or above a certain range or dropped audio packets, can affect the output of the audio content of the multimedia channel. Such artifacts can be detected by video and audio decoders using any of a variety of techniques well known in the art.

While no artifact is detected at block 210, the STB device 150 continues to monitor the processing and presentation of the multimedia channel. Otherwise, in the event that an artifact is detected by the STB device 150 at decision block 210, the STB device 150 can generate an error indicator and send the error indicator to the content distribution network 102 for processing at block 212. The STB device 150 also continues to monitor the processing and presentation of the multimedia channel for artifacts.

In at least one embodiment, rather than generating an error indicator for each and every artifact identified at block 210, the STB device 150 is configured to apply one or more error reporting filter criteria to identified artifacts so that error indicators are selectively generated and sent only under certain conditions. The error reporting filter criteria can include criteria regarding the artifact type. To illustrate, certain types of artifacts may be expected to degrade the presentation of the multimedia channel more than others and thus the error reporting filter criteria can limit error indicator generation for those artifact types that are not expected to significantly impact the presentation of the multimedia channel. The error reporting filter criteria further can include criteria regarding the duration of an artifact. To illustrate, a temporary artifact may not necessitate remediation and thus temporary artifacts can be filtered out by ensuring that the artifact is observed for a minimum duration before generating an error report indicator. In a related manner, the error reporting filter criteria can include criteria regarding the frequency of appearance of certain artifacts. To illustrate, one or a few dropped video packets or audio packets may not indicate a problem with the multimedia channel or a problem with the content distribution network 102, whereas the frequent dropping of video packets or audio packets may indicate otherwise. Accordingly, the STB device 150 can limit the generation of an error indicator for certain types of artifacts unless the frequency of the artifact exceeds a set threshold. Other filtering criteria may be implemented using the guidelines provided herein without departing from the scope of the present disclosure.

The error indicator generated by the STB device 150 can implement any of a variety of formats. To illustrate, the error indicator can include fields to store values representative of: the multimedia channel affected; the artifact type (e.g., macroblocking, tiling, dropped packet, etc.); the frequency or duration of the artifact; a value representative of the magnitude of the artifact (e.g., number of dropped packets, detected chroma level, etc); an identifier associated with the viewer; a model or serial number of the STB 150; certain configuration settings of the STB 150; and the like. In at least one embodiment, the error indicator is configured as a SNMP trap message and is transmitted to the local channel status server via the SNMP protocol.

At block 214, the content distribution network 102 receives and processes the error indicator generated and sent by the STB device. In one embodiment, the error indicator is supplied to the channel status server of the corresponding local tier. The channel status server can forward the error indicator to the channel status server 136 of the central tier, either separately or together with other error indicators as an error report. In another embodiment, the channel status server at the local tier filters error indicators based on the application of one or more error reporting filter criteria. The channel status server of the local tier can use the same error reporting filter criteria used by the STB device 150, or criteria configured for the local tier may be used. To illustrate, rather than filter based on the frequency, duration, or type of artifact at a single STB device, the error reporting filter criteria implemented by the channel status server can include, for example, criteria regarding a minimum number of STB devices 150 reporting the same or similar artifact. Further, the error reporting filter criteria implemented at one local tier may differ from the error reporting filter criteria of a different local tier due to particular attributes of the local tiers. To illustrate, one local tier may be operating in an environment whereby the communications network is more heavily trafficked or is less reliable, and thus it may employ higher thresholds for certain types of filtering thresholds (e.g., dropped packet rates).

In the event that an error report is warranted, the channel status server of the local tier generates an error report and provides the error report to the channel status server 136 of the central tier 112. As with the error indicators generated by the STB device 150, the error reports can include an SNMP trap message or other similar message. An error report can include fields to store values representative of: the multimedia channel affected; the artifact type; the artifact duration; the number of STB devices 150 reporting the artifact; and the like.

At block 216, the channel status server 136 determines whether an alarm report is warranted based on one or more error reports received from the channel status servers 138 and 140 of the local tiers. As with the error indicators and error reports, the channel status server 136 can use one or more error reporting filter criteria in determining whether to generate an alarm report. In the event that an alarm report is not warranted, the channel status server 136 awaits the next error report at block 218. Otherwise, if an alarm report is warranted, the channel status server 136 generates the alarm report and provides it for reception by technical staff at block 220. The alarm report can include information regarding, for example, the multimedia channel(s) affected, how they are affected, the scope (e.g., location or portion of the content distribution network 102) of the problem, and the like. The alarm report can be provided as an email, a faxed report, a pager message or text message, a display screen on a monitor, and the like. In response to receiving the alarm report, technical staff of the service provider can take steps to correct the problems with the reported multimedia channels.

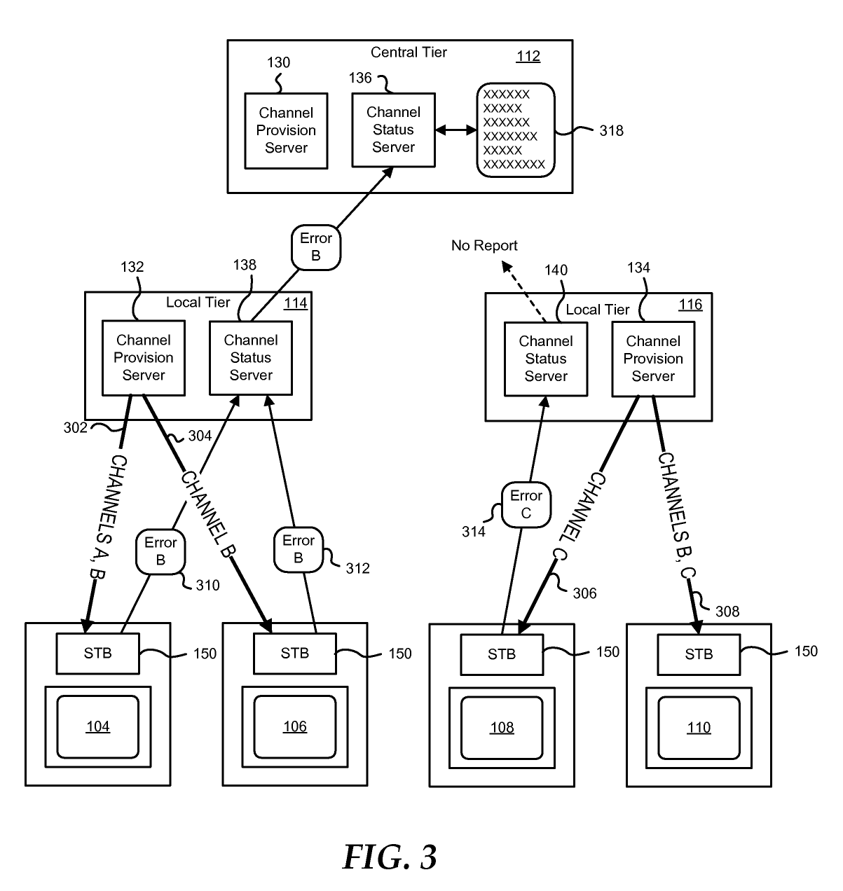

FIG. 3 illustrates an example operation of the multimedia content distribution system 100 with respect to error reporting in accordance with at least one embodiment of the present disclosure. In this example, the viewer at viewer premises 104 requests multimedia channels A and B, the viewer at viewer premises 106 requests multimedia channel B, the viewer at viewer premises 108 requests multimedia channel C, and the viewer at viewer premises 110 requests multimedia channels B and C. Accordingly, the channel provision server 132 provides multimedia data 302 representative of multimedia channels A and B to the STB device 150 of the viewer premises 104 and provides multimedia data 304 representative of multimedia channel B to the STB device 150 of the viewer premises 106. The channel provision server 134 provides multimedia data 306 representative of multimedia channel C to the STB device 150 of the viewer premises 108 and provides multimedia data 308 representative of the multimedia channels B and C to the STB device 150 of the viewer premises 110. The STB devices 150 process their respective received multimedia data for the presentation of the corresponding video and audio content.

In the illustrated example, the STB devices 150 of the viewer premises 104 and the viewer premises 106 identify an artifact in multimedia channel B and, in response, provide error indicators 310 and 312, respectively, to the channel status server 138. However, this artifact in multimedia channel B is limited to the network segment associated with the local tier 114 and thus the STB devices 150 of the viewer premises 108 and the viewer premises 110 do not identify or report a problem with multimedia channel B. Further, the STB device 150 of viewer premises 108 identifies an artifact in multimedia channel C during processing and thus generates an error indicator 314 and provides the error indicator 314 to the channel status server 140. In this example, the artifact in the multimedia channel C is limited to the connection between the viewer premises 108 and the local tier 116 and thus is not identified or reported by the STB device 150 of the viewer premises 110.

The channel status server 138 determines that an error report is warranted based on the receipt of the error indicators 310 and 312 and thus generates an error report 316 for the channel status server 136 of the central tier 112. For example, the receipt of two error indicators for the same artifact on the same multimedia channel may meet a threshold criterion of the channel status server 138. Conversely, the channel status server 140 determines that the receipt of the single error indicator 314 for multimedia channel C does not warrant an error report and thus no error report is generated by the channel status server 314 for the identified artifact in multimedia channel C. To illustrate, the error indicator 314 could indicate that the network between the local tier 116 and the viewer premises 108 is dropping video packets for multimedia channel C, but because the other viewer premises of the local tier 116 are not experiencing the same problem, it may not necessitate immediate resolution.

The video server 136 receives the error report 316 and, in response, generates an alarm report 318 which includes information from the error report 316, as well as information from error reports generated by other local tiers. The error report 316 then can be utilized by technical staff to identify the circumstances that resulted in the reported error and take steps to correct the problem.

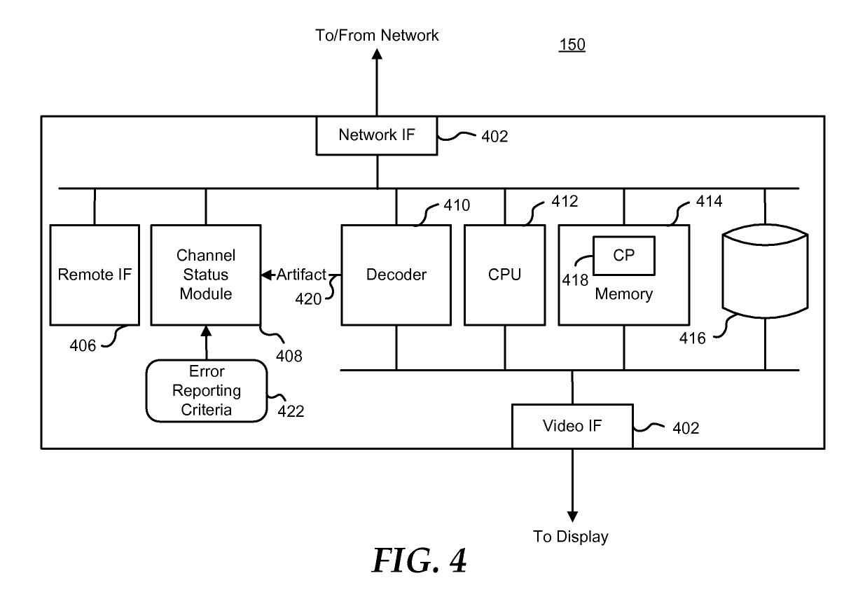

FIG. 4 illustrates an example implementation of the STB device 150 of FIG. 1 in accordance with at least one embodiment of the present disclosure. The STB device 150 includes a network interface 402, a video interface 404, a remote interface 406, a video status module 408, a multimedia decoder 410, a central processing unit (CPU) 412 or other processor, and one or more computer readable mediums, such as a memory 414 and a hard drive 416. In the illustrated example, the memory 414 (or alternately the hard drive 416) stores a computer program 418 representing instructions executable by the CPU 412 or other component of the STB device 150 that manipulate the CPU 412 or other component to perform the functionality described herein.

The network interface 402 is configured to interface with a network for communications with a local tier and therefore includes an interface compatible with the network type of the local tier, such as an Ethernet interface, a digital subscriber line (DSL) modem, a fiber optic interface, and the like. The remote interface 406 includes an infrared interface or radio frequency (RF) interface for receiving command signals from a remote control or a button panel. The video interface 404 is configured to interface with, and control the operation of, the display device 152 (FIG. 1). To illustrate, the video interface 404 can include an high-definition multimedia interface (HDMI), a digital video interface (DVI), a National Television Standards Committee (NTSC)-based coaxial cable interface, an S-video interface, audio outputs, and the like.

The multimedia decoder 410, in one embodiment, is configured to decode encoded multimedia data received via the network interface 402 and provide the resulting video and audio streams for output to the display device via the video interface 404. The multimedia decoder 410 can include, for example, an MPEG decoder, an H.264 decoder, and the like. During decoding or subsequent processing, the multimedia decoder 410 may identify artifacts that affect the presentation of the multimedia channel being processed. To illustrate, the multimedia decoder 410 may identify missing video packets or audio packets, an audio level that is above or below an expected range, a chroma level or luminance level that is above or below an expected range, or the multimedia decoder 410 may identify macroblocking, tiling, or tearing in video content. In response to identifying an artifact during processing, the multimedia decoder 410 is configured to generate an artifact indicator 420 and supply the artifact indicator 420 to the video status module 408.

The video status module 408 is configured to generate error indicators for transmission to the local tier via the network interface 402 based on the artifact indicators 416 provided by the multimedia decoder 410. The video status module 408, in one embodiment, is configured to selectively generate error indicators based on the application of error reporting filter criteria 422 to received artifact indicators 416. To illustrate, the error reporting filter criteria 422 may specify that only certain types of artifacts, artifacts of a minimum duration, or artifacts of a certain minimum frequency may give rise to the generation of an error indicator and thus the error reporting filter criteria 422 can be used to limit the generation of error indicators in instances where the specified criteria are not met. The video status module 408 can be implemented as hardware, software, firmware, or a combination thereof. To illustrate, the video status module 408 can be implemented as a SNMP trap client program implemented as a set of instructions of the computer program 418 that are configured to manipulate the CPU 412 to perform the functions described herein.

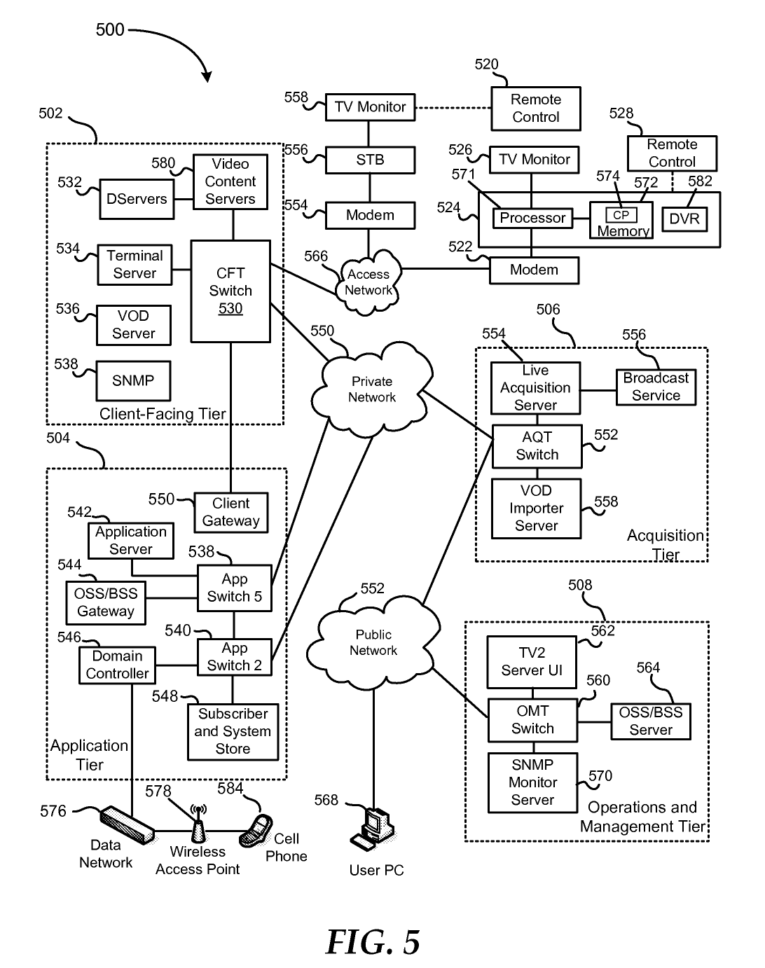

FIG. 5 illustrates an example Internet Protocol Television (IPTV) system 500 in which the disclosed video monitoring techniques can be implemented in accordance with at least one embodiment of the present disclosure. The IPTV system 500 can include a client facing tier 502, an application tier 504, an acquisition tier 506, and an operations and management tier 508. Each tier 502, 504, 506, and 508 is coupled to a private network 510, a public network 512, or both the private network 510 and the public network 512. For example, the client-facing tier 502 can be coupled to the private network 510. Further, the application tier 504 can be coupled to the private network 510 and to the public network 512, such as the Internet. The acquisition tier 506 can also be coupled to the private network 510 and to the public network 512. Moreover, the operations and management tier 508 can be coupled to the public network 512.

The various tiers 502, 504, 506, and 508 communicate with each other via the private network 510 and the public network 512. For instance, the client-facing tier 502 can communicate with the application tier 504 and the acquisition tier 506 via the private network 510. The application tier 504 can also communicate with the acquisition tier 506 via the private network 510. Further, the application tier 504 can communicate with the acquisition tier 506 and the operations and management tier 508 via the public network 512. Moreover, the acquisition tier 506 can communicate with the operations and management tier 508 via the public network 512. In a particular embodiment, elements of the application tier 504 can communicate directly with the client-facing tier 502.

The client-facing tier 502 can communicate with user equipment via a private access network 566, such as an Internet Protocol Television (IPTV) network. In an illustrative embodiment, modems, such as a first modem 514 and a second modem 522 can be coupled to the private access network 566. The client-facing tier 502 can communicate with a first representative set-top box device (STB) 516 via the first modem 514 and with a second representative set-top box device 524 via the second modem 522. The client-facing tier 502 can communicate with a large number of set-top boxes, such as the representative set-top boxes 516 and 524, over a wide geographic area, such as a regional area, a metropolitan area, a viewing area, or any other suitable geographic area that can be supported by networking the client-facing tier 502 to numerous set-top box devices. In an illustrative embodiment, the client facing tier or any portion thereof can be included at a video head-end office.

In one embodiment, the client-facing tier 502 can be coupled to the modems 514 and 522 via fiber optic cables. Alternatively, the modems 514 and 522 can be digital subscriber line (DSL) modems that are coupled to one or more network nodes via twisted pairs, and the client-facing tier 502 can be coupled to the network nodes via fiber-optic cables. Each set-top box device 516 and 524 can process data received through the private access network 566 via an IPTV software platform such as Microsoft® TV IPTV Edition.

Additionally, the first set-top box device 516 can be coupled to a first display device 518, such as a first television monitor, and the second set-top box device 524 can be coupled to a second display device 526, such as a second television monitor. Moreover, the first set-top box device 516 can communicate with a first remote control 520, and the second set-top box device can communicate with a second remote control 528. In an exemplary, non-limiting embodiment, each set-top box device 516 and 524 can receive data or video from the client-facing tier 502 via the private access network 566 and render or display the data or video at the display devices 518 and 526 to which it is coupled. In an illustrative embodiment, the set-top box devices 516 and 524 can include tuners that receive and decode television programming information for transmission to the display devices 518 and 526. The television tuner can be National Television System Committee (NTSC) tuner, an Advanced Television System Committee (ATSC), another suitable analog or digital tuner, or any combination thereof. A signal for a television channel can pass through the tuner before the content is displayed on a monitor.

In an exemplary, non-limiting embodiment, STB devices 516 and 524 can receive video content, which may include video and audio portions, from the client-facing tier 502 via the private access network 566. The STB device 516 and 524 can transmit the video content to an external display device, such as the television monitors 518 and 526. The STB devices 516 and 524 can also communicate commands received from the remote control devices 520 and 528 to the client-facing tier 502 via the private access network 566.

In an illustrative embodiment, the client-facing tier 502 can include a client-facing tier (CFT) switch 530 that manages communication between the client-facing tier 502 and the private access network 566 and between the client-facing tier 502 and the private network 510. As shown, the CFT switch 530 is coupled to one or more data servers 532 that store data transmitted in response to user requests, such as video-on-demand material. The CFT switch 530 can also be coupled to a terminal server 534 that provides terminal devices, such as a game application server 568 and other devices with a common connection point to the private network 510. In a particular embodiment, the CFT switch 530 can also be coupled to a video-on-demand (VOD) server 536 that stores or provides VOD content imported by the IPTV system 500. The client-facing tier 502 can also include one or more channel provision servers 580 that transmit video content requested by viewers via their STB devices 516 and 524. In an illustrative, non-limiting embodiment, the channel provision servers 580 can include one or more multicast servers. The client-facing tier 502 further can include an SNMP monitor server 538 (one embodiment of the channel status servers 138 and 140, FIG. 1) that is configured to process error indicators from the STB devices as described above.

As shown in FIG. 5, the application tier 504 can communicate with both the private network 510 and the public network 512. In this embodiment, the application tier 504 can include a first application tier (APP) switch 538 and a second APP switch 540. In a particular embodiment, the first APP switch 538 can be coupled to the second APP switch 540. The first APP switch 538 can be coupled to an application server 542 and to an OSS/BSS gateway 544. The application server 542 provides applications to the set-top box devices 516 and 524 via the private access network 566, so the set-top box devices 516 and 524 can provide functions, such as display, messaging, processing of IPTV data and VOD material, etc. In a particular embodiment, the OSS/BSS gateway 544 includes operation systems and support (OSS) data, as well as billing systems and support (BSS) data.

Further, the second APP switch 540 can be coupled to a domain controller 546 that provides web access, for example, to users via the public network 512. The second APP switch 540 can be coupled to a subscriber and system store 548 that includes account information, such as account information that is associated with users who access the system 500 via the private network 510 or the public network 512. In a particular embodiment, the application tier 504 can also include a client gateway 550 that communicates data directly to the client-facing tier 502. In this embodiment, the client gateway 550 can be coupled directly to the CFT switch 530. The client gateway 550 can provide user access to the private network 510 and the tiers coupled thereto.

In a particular embodiment, the set-top box devices 516 and 524 can access the system via the private access network 566, using information received from the client gateway 550. The private access network 566 provides security for the private network 510. User devices can access the client gateway 550 via the private access network 566, and the client gateway 550 can allow such devices to access the private network 510 once the devices are authenticated or verified. Similarly, the client gateway 550 can prevent unauthorized devices, such as hacker computers or stolen set-top box devices from accessing the private network 510, by denying access to these devices beyond the private access network 566.

For example, when a set-top box device 516 accesses the system 500 via the private access network 566, the client gateway 550 can verify subscriber information by communicating with the subscriber and system store 548 via the private network 510, the first APP switch 538 and the second APP switch 540. Further, the client gateway 550 can verify billing information and status by communicating with the OSS/BSS gateway 544 via the private network 510 and the first APP switch 538. The OSS/BSS gateway 544 can transmit a query across the first APP switch 538 to the second APP switch 540, and the second APP switch 540 can communicate the query across the public network 512 to an OSS/BSS server 564. After the client gateway 550 confirms subscriber and/or billing information, the client gateway 550 can allow the set-top box device 516 access to IPTV content and VOD content. If the client gateway 550 cannot verify subscriber information for the set-top box device 516, for example because it is connected to a different twisted pair, the client gateway 550 can deny transmissions to and from the set-top box device 516 beyond the private access network 566.

The acquisition tier 506 includes an acquisition tier (AQT) switch 552 that communicates with the private network 510. The AQT switch 552 can also communicate with the operations and management tier 508 via the public network 512. In a particular embodiment during operation of the IPTV system, the live acquisition server 554 can acquire television or movie content. The live acquisition server 554 can transmit the television or movie content to the AQT switch 552, and the AQT switch can transmit the television or movie content to the CFT switch 530 via the private network 510.

Further, the television or movie content can be transmitted to the channel provision servers 580, where it can be encoded, formatted, stored, or otherwise manipulated and prepared for communication to the STB devices 516 and 524. The CFT switch 530 can communicate the television or movie content to the modems 514 and 522 via the private access network 566. The STB devices 516 and 524 can receive the television or movie content via the modems 514 and 522, and can transmit the television or movie content to the television monitors 518 and 526. In an illustrative embodiment, video or audio portions of the television or movie content can be streamed to the STB devices 516 and 524.

Further, the AQT switch can be coupled to a VOD importer server 558 that stores television or movie content received at the acquisition tier 506 and communicates the stored content to the VOD server 536 at the client-facing tier 502 via the private network 510. Additionally, at the acquisition tier 506, the VOD importer server 558 can receive content from one or more VOD sources outside the IPTV system 500, such as movie studios and programmers of non-live content. The VOD importer server 558 can transmit the VOD content to the AQT switch 552, and the AQT switch 552, in turn, can communicate the material to the CFT switch 530 via the private network 510. The VOD content can be stored at one or more servers, such as the VOD server 536.

When users issue requests for VOD content via the STB devices 516 and 524, the requests can be transmitted over the private access network 566 to the VOD server 536 via the CFT switch 530. Upon receiving such requests, the VOD server 536 can retrieve the requested VOD content and transmit the content to the STB devices 516 and 524 across the private access network 566 via the CFT switch 530. The STB devices 516 and 524 can transmit the VOD content to the television monitors 518 and 526. In an illustrative embodiment, video or audio portions of VOD content can be streamed to the STB devices 516 and 524.

The operations and management tier 508 can include an operations and management tier (OMT) switch 560 that conducts communication between the operations and management tier 508 and the public network 512. In the embodiment illustrated by FIG. 5, the OMT switch 560 is coupled to a TV2 server 562. Additionally, the OMT switch 560 can be coupled to the OSS/BSS server 564 and to a simple network management protocol (SNMP) monitor 570 (one embodiment of the channel status server 136 of FIG. 1) that monitors network devices within or coupled to the IPTV system 500. In a particular embodiment, the OMT switch 560 can communicate with the AQT switch 552 via the public network 512.

In a particular embodiment during operation of the IPTV system, the live acquisition server 554 can acquire television content from the broadcast service 556. The live acquisition server 554 can transmit the television or movie content to the AQT switch 552, and the AQT switch 552 in turn can transmit the television content to the CFT switch 530 via the private network 510 or to the OMT switch 560 via the public network 512. Further, the television content can be encoded at the D-servers 532, and the CFT switch 530 can communicate the television content to the modems 514 and, 522 via the private access network 566. The set-top box devices 516 and 524 can receive the television content from the modems 514 and 522, decode the television content, and transmit the content to the display devices 518 and 526 according to commands from the remote control devices 520 and 528.

Additionally, at the acquisition tier 506, the video-on-demand (VOD) importer server 558 can receive content from one or more VOD sources outside the IPTV system 500, such as movie studios and programmers of non-live content. The VOD importer server 558 can transmit the VOD content to the AQT switch 552, and the AQT switch 552 in turn can communicate the material to the CFT switch 530 via the private network 510. The VOD content can be stored at one or more servers, such as the VOD server 536.

When a user issues a request for VOD content to set-top box devices 516 and 524, the request can be transmitted over the private access network 566 to the VOD server 536 via the CFT switch 530. Upon receiving such a request, the VOD server 536 can retrieve requested VOD content and transmit the content to the set-top box devices 516 and 524 across the private access network 566 via the CFT switch 530. In an illustrative embodiment, the live acquisition server 554 can transmit the television content to the AQT switch 552, and the AQT switch 552 in turn can transmit the television content to the OMT switch 560 via the public network 512. In this embodiment, the OMT switch 560 can transmit the television content to the TV2 server 562 for display to users accessing the user interface at the TV2 server. For example, a user can access the TV2 server 562 using a personal computer 568 coupled to the public network 512.

The domain controller 546 communicates with the public network 512 via the second APP switch 540. Additionally, the domain controller 546 can communicate via the public network 512 with the personal computer 568. For example, the domain controller 546 can display a web portal via the public network 512 and allow users to access the web portal using the PC 568. Further, in an illustrative embodiment, the domain controller 546 can communicate with at least one wireless network access point 578 over a data network 576. In this embodiment, each wireless network access device 578 can communicate with user wireless devices, such as a cellular telephone 584.

In a particular embodiment, a set-top box device such as the second set-top box device 524 can include an STB processor 571 and an STB memory device 572 that is accessible to the STB processor 571. The set-top box device 524 also includes a STB computer program 574 that is embedded within the STB memory device 572. In a particular embodiment, the STB computer program 574 can contain instructions to receive and execute at least one user television viewing preference that a user has entered by accessing an Internet user account via the domain controller 546. For example, the user can use the PC 568 to access a web portal maintained by the domain controller 546 via the Internet. The domain controller 546 can query the subscriber and system store 548 via the private network 510 for account information associated with the user. In a particular embodiment, the account information can associate the user's Internet account with the second set-top box device 524. For instance, in an illustrative embodiment, the account information can relate the user's account to the second set-top box device 524, by associating the user account with an IP address of the second set-top box device with data relating to one or more twisted pairs connected with the second set-top box device 524, with data related to one or more fiber optic cables connected with the second set-top box device 524, with an alphanumeric identifier of the second set-top box device 524, with any other data that is suitable for associating second set-top box device 524 with a user account, or with any combination of these.

The STB computer program 574 can contain instructions to receive many types of user preferences from the domain controller 546 via the access network 566. For example, the STB computer program 574 can include instructions to receive a request to record at least one television program at a video content storage module such as a digital video recorder (DVR) 582 within the second set-top box device 524. In this example embodiment, the STB computer program 574 can include instructions to transmit the request to the DVR 582, where the television program(s) are recorded. In an illustrative embodiment, the STB computer program 574 can include instructions to receive from the DVR 582 a recording status with respect to one or more of the television programs and to transmit at least one message regarding the status to a wireless device, such as the cellular telephone 584. The message can be received at the CFT switch 530, for instance, and communicated to the domain controller 546 across the private network 510 via the second APP switch 540. Further, the domain controller 546 can transmit the message to the wireless data network 576, directly or via the public network 512, and on to the wireless network access point 578. The message can then be transmitted to the cellular telephone 584. In an illustrative embodiment, the status can be sent via a wireless access protocol (WAP). Further details of the IPTV system are taught in U.S. Patent Application Publication No. 2007/0199041, the disclosure of which is hereby incorporated by reference.

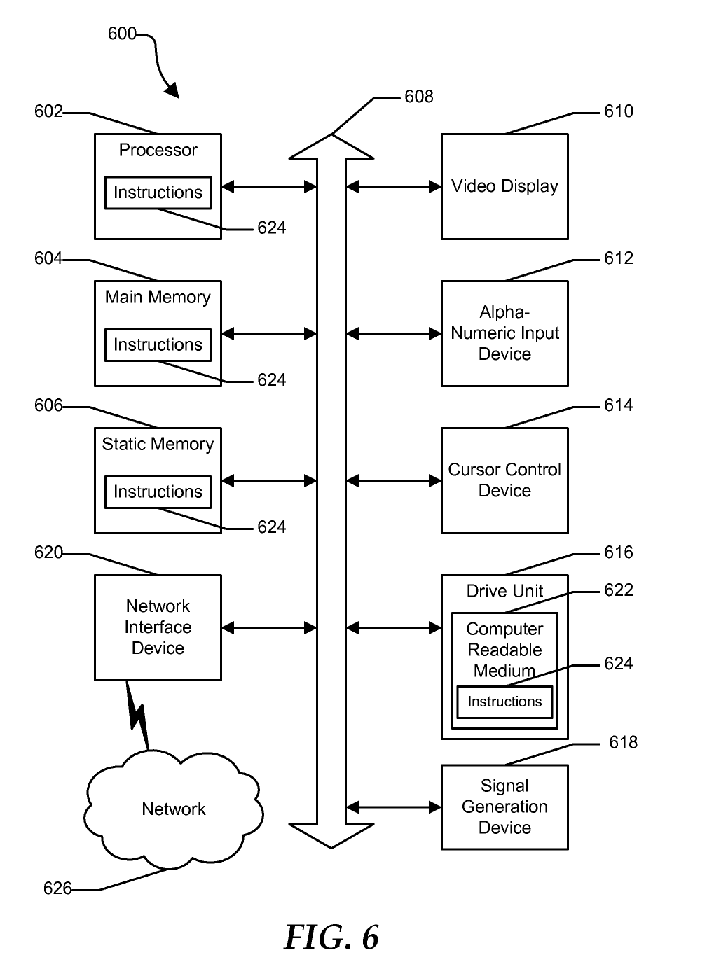

FIG. 6 shows an illustrative embodiment of a general computer system 600 in accordance with at least one embodiment of the present disclosure. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into, for example, a STB device. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602, e.g., a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

What is claimed is:

1. A method comprising:
receiving, at a set top box (STB) device located at a viewer's premises, multimedia data representative of a multimedia channel from a service provider;
processing, at the STB device, the multimedia data for presentation of the multimedia channel at a display device located at the viewer's premises;
identifying, at the STB device, an artifact during the processing of the multimedia data that is expected to affect the presentation of the multimedia channel;
generating, at the set top box, an error indicator based on the artifact; and
providing the error indicator for reception by the service provider.

2. The method of claim 1, wherein:
the multimedia data comprises encoded multimedia data; and
processing the multimedia data comprises decoding the multimedia data to generate a video stream and an audio stream representative of the multimedia channel.

3. The method of claim 2, wherein identifying an artifact comprises at least one of identifying a visual artifact of the video stream and identifying an audible artifact of the audio stream.

4. The method of claim 1, wherein the artifact comprises one selected from a group consisting of: macroblocking; tiling; frame tearing; a dropped video packet; a dropped audio packet; a blank screen output; an audio level outside of a predetermined range; and a chroma level outside of a predetermined range.

5. The method of claim 1, wherein generating the error indicator comprises selectively generating the error indicator based on an application of an error reporting filter criterion to the artifact.

6. The method of claim 5, wherein the error reporting filter criterion comprises one selected from a group consisting of: an artifact type criterion; an artifact duration criterion; and an artifact frequency criterion.

7. The method of claim 1, wherein:
receiving the multimedia data comprises receiving the multimedia data via an Internet Protocol (IP)-based network; and
providing the error indicator comprises providing the error indicator via the IP-based network.

8. The method of claim 1, wherein the error indicator comprises a Simple Network Management Protocol (SNMP) trap message.

9. The method of claim 1, further comprising:
receiving, at the service provider, the error indicator; and
generating, at the service provider, an error report based on the error indicator.

10. The method of claim 9, wherein generating the error report comprises selectively generating the error report based on an application of an error reporting filter criterion to the error indicator.

11. A system comprising:
a set top box (STB) device comprising:
an interface to receive multimedia data representative of a multimedia channel;
a multimedia decoder configured to process the multimedia data to generate a video stream and an audio stream;
a channel status module to generate an error indicator in response to identifying an artifact that is expected to affect a presentation of the multimedia channel; and
the interface further to provide the error indicator for reception by a service provider.

12. The system of claim 11, wherein the STB device is connected to the service provider via a communications network and the interface comprises a network interface to the communications network.

13. The system of claim 12, wherein the communications network comprises an Internet Protocol (IP)-based network.

14. The system of claim 11, wherein the channel status module comprises:
a processor; and
a memory to store a set of instructions, the set of instructions comprising instructions configured to manipulate the processor to generate the error indicator based on an artifact indicator received from the multimedia decoder, the artifact indicator representative of the artifact.

15. The system of claim 14, wherein the instructions configured to manipulate the processor to generate the error indicator comprise instructions configured to manipulate the processor to selectively generate the error indicator based on an application of an error reporting filter criterion to the artifact indicator.

16. The system of claim 15, wherein the error reporting filter criterion comprises one selected from a group consisting of: an artifact type criterion; an artifact duration criterion; and an artifact frequency criterion.

17. The system of claim 11, wherein the channel status module comprises a Simple Network Management Protocol (SNMP) trap client and the error indicator comprises an SNMP trap message.

18. The system of claim 11, wherein the artifact comprises one selected from a group consisting of: macroblocking; tiling; frame tearing; a dropped video packet; a dropped audio packet; a blank screen output; an audio level outside of a predetermined range; and a chroma level outside of a predetermined range;

19. The system of claim 11, further comprising:
the service provider, wherein the service provider is configured to selectively generate an error report for the multimedia channel based on an application of an error reporting filter criterion to the error indicator.

20. A set top box (STB) device comprising:
a processor; and
a computer readable medium embodying a set of instructions, the set of instructions configured to manipulate the processor to:
process multimedia data representative of a multimedia channel for presentation at a display device located at the viewer's premises;
identify, during processing of the multimedia data, an artifact that is expected to affect the presentation of the multimedia channel;
generate an error indicator based on the artifact; and
provide the error indicator for transmission to a service provider.

21. A method comprising:
receiving, at a service provider, a first error indicator from a first set top box (STB) device located at a viewer's premises, the first error indicator identifying an artifact in a presentation of a multimedia channel detected by the first STB device; and
generating, at the service provider, an error report based on the first error indicator.

22. The method of claim 21, further comprising:
receiving, at the service provider, a second error indicator from a second set top box (STB) device located at a viewer's premises, the second error indicator identifying an artifact in a presentation of a multimedia channel detected by the second STB device; and
generating, at the service provider, the error report based on the second error indicator.

23. The method of claim 21, wherein generating the error report comprises selectively generating the error report based on an application of an error reporting filter criterion to the first error indicator.
